(19) United States
(12) Patent Application Publication
(10) Pub. No.: US 2025/0363903 A1
(43) Pub. Date: Nov. 27, 2025

(54) SYSTEM AND METHODOLOGY THAT UTILIZES ARTIFICIAL INTELLIGENCE TO FACILITATE CONVERSATIONAL LEARNING

(71) Applicant: Parsec Education, Inc., Fresno, CA (US)

(72) Inventor: Eugene Park, Clovis, CA (US)

(21) Appl. No.: 19/218,094

(22) Filed: May 23, 2025

Related U.S. Application Data
(60) Provisional application No. 63/651,900, filed on May 24, 2024.

(51) Int. Cl. G09B 7/00; G06F 40/40

(52) U.S. Cl. CPC G09B 7/00; G06F 40/40

(57) ABSTRACT

Various aspects related to utilizing artificial intelligence to facilitate conversational learning are disclosed. In one such aspect, a method is provided, which includes initiating a generative artificial intelligence (AI) conversation with a learner in which the generative AI conversation is facilitated by an AI large language model (LLM) and configured to elicit learning data from the learner. The method further includes creating a learner profile of the user based on the learning data elicited from the learner, and continuously adapting at least one of the generative AI conversation or the learner profile using the AI LLM based on subsequent learning data elicited from the learner.

### CROSS-REFERENCE TO RELATED APPLICATIONS

This application claims the benefit of U.S. Provisional Patent Application Ser. No. 63/651,900, filed May 24, 2024, which is titled “SYSTEM AND METHODOLOGY THAT UTILIZES ARTIFICIAL INTELLIGENCE TO FACILITATE CONVERSATIONAL LEARNING” and its entire contents of which are incorporated herein by reference.

### TECHNICAL FIELD

The subject disclosure generally relates to learning, and more specifically to a system and methodology that utilizes artificial intelligence to facilitate conversational learning.

### BACKGROUND

Conventional learning and assessment techniques have many limitations. For instance, because conventional educational assessment techniques lack personalization, current models of assessing learners do not reflect individual learning styles or progress. Tests such as the Computer Adaptive Test (CAT), for example, like the Graduate Record Examination, Smarter Balanced Assessments, and the Scholastic Aptitude Test, adjust the difficulty level of questions based on test taker responses. Although such assessments allow for the measurement of a learner's knowledge of discrete standards relative to a peer group, they produce lagging data and do not capture a range of learner strengths, interests, and cognitive and social-emotional skills that can be translated into clear feedback useful for learners, educators, systems leaders, and policymakers.

Conventional techniques also exhibit an undesirable disconnect between assessment and learning. Standardized assessments have thus become the antithesis of personalized assessments since they are poorly aligned with individual learning processes and do not measure unique talents or interests effectively. Moreover, the current assessment model in education draws a line between learning and assessment, wherein learning happens first and is then evaluated by an assessment of learning, and wherein gaps in learning are addressed through remediation. Recent educational research, however, has emphasized the primary importance of assessment for learning (formative assessment), whereby learners and educators may close gaps in knowledge through dialogue and self-reflection. Although some educational technology companies have created feedback tools for discrete skills, none have developed an iterative formative tool that invites inquiry and builds knowledge while capturing evidence of learning, and aggregating the evidence into a larger picture of learner strengths, interests, cognitive, social, and emotional skills.

Conventional techniques also inadequately harness and encourage a learner's natural curiosity, which often results in disinterested learners that sub-optimally perform. To this end, it should be noted that because assessments in the current model of education are generally designed for learners rather than by learners, individual learners have little to no part in developing the learning goals to be assessed, identifying subject matter for assessments, or deciding how to demonstrate their knowledge. Inquiry-based learning has long been foundational to successful pedagogical approaches, like the International Baccalaureate (IB) Programme. However, access to this rich learning remains limited since building structured inquiry for learners is labor and resource intensive. Further, dominant high-stakes assessments do not evaluate the range of learner strengths, interests, cognitive, social, and emotional skills valued in inquiry-based models. Moreover, no education technology platform has successfully bridged ongoing inquiry-based learning with comprehensive assessment for learning.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with utilizing artificial intelligence to facilitate conversational learning. In one such aspect, a method is provided, which includes initiating a generative artificial intelligence (AI) conversation with a learner in which the generative AI conversation is facilitated by an AI large language model (LLM) and configured to elicit learning data from the learner. The method further includes creating a learner profile of the user based on the learning data elicited from the learner, and continuously adapting at least one of the generative AI conversation or the learner profile using the AI LLM based on subsequent learning data elicited from the learner.

In a further aspect, another method is provided, which includes initiating a first generative AI conversation with a learner in which the first generative AI conversation is facilitated by an AI LLM and configured to elicit learning data from the learner. The method further includes creating a learner profile of the user based on the learning data elicited from the learner, and initiating a second generative AI conversation with a learner associate in which the second generative AI conversation is configured to elicit supplemental learning data from the learner associate corresponding to the learner profile. The method also includes continuously adapting the first generative AI conversation using the AI LLM based on a combination of the learning data elicited from the learner and the supplemental learning data elicited from the learner associate.

In yet another aspect, another method is provided, which includes initiating a generative AI conversation with a learner in which the generative AI conversation is facilitated by an AI LLM and configured to elicit learning data from the learner corresponding to at least one of a social-emotional skills profile of the learner or an executive function skills profile of the learner. The method further includes creating a learner profile of the user based on the learning data elicited from the learner, and continuously adapting at least one of the generative AI conversation or the learner profile using the AI LLM based on subsequent learning data elicited from the learner. The method also includes generating a strategy to strengthen the at least one of the social-emotional skills profile of the learner or the executive function skills profile of the learner.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates conversational learning in accordance with an aspect of the subject specification;

FIG. 2 is a block diagram illustrating an exemplary conversational learning embodiment in accordance with an aspect of the subject specification;

FIG. 3 is a first flow diagram of an exemplary conversational learning methodology in accordance with an aspect of the subject specification;

FIG. 4 illustrates a block diagram of an exemplary conversational learning system that facilitates implementing aspects disclosed herein;

FIG. 5 is a second flow diagram of an exemplary conversational learning methodology in accordance with an aspect of the subject specification;

FIG. 6 is a block diagram representing exemplary non-limiting networked environments in which various embodiments described herein can be implemented; and

FIG. 7 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which

overcomes the various limitations of conventional learning and assessment techniques. The embodiments disclosed herein are directed towards overcoming such limitations by providing a system and methodology that utilizes artificial intelligence (AI) to facilitate conversational learning. For instance, in a particular embodiment, an AI-Driven Conversational Learning and Assessment System (AI-CLAS) is disclosed, wherein the AI-CLAS uses a large language model (LLM) to generate responses and interact with learners in a conversational video or audio format, and wherein the model is generative and extractive. Within such embodiment, it is contemplated that the LLM may be coupled with a data model that includes extractive data from a learner's input over time, thus creating a robust, predictive learner profile (user data model).

In a particular aspect disclosed herein, the AI-CLAS may be configured to perform any of a plurality of tasks including, for example: 1) eliciting curiosity and interests from learners; 2) evaluating the knowledge, skills, and abilities of learners; 3) connecting learners with empathy and support (e.g., differentiated resources); 4) engaging learners in dialogue that continually challenges them in their zone of proximal development through activities, scenarios, tasks, projects, and other immersive learning experiences; 5) monitoring a learner's interests, capacities, and goals to evolve continually in parallel with the learner; and 6) facilitating a continuous feedback loop between the teacher and learner, where the learner's strengths, needs, and interests are clarified and form the substance of meaningful teacher guidance.

### Exemplary Embodiments

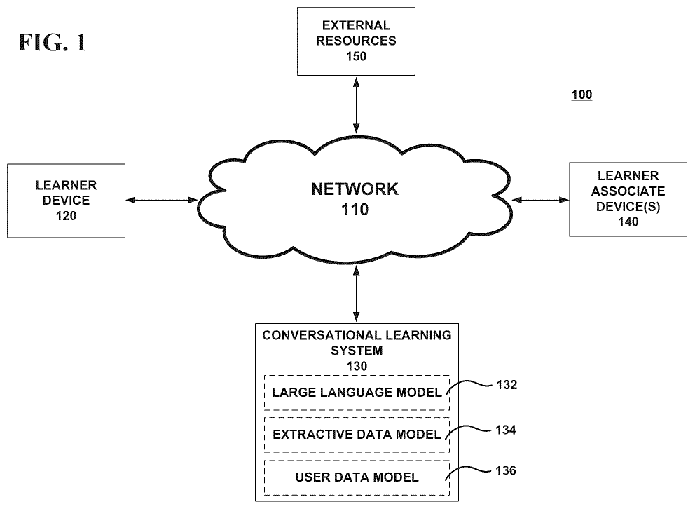

Turning now to FIG. 1, an exemplary environment that facilitates conversational learning according to an embodiment is provided. As illustrated, environment 100 includes a coupling of learner device 120, conversational learning system 130, learner associate device(s) 140, and external resources 150 via network 110 (e.g., the Internet, a radio frequency identification (RFID) network, a Bluetooth network, etc.). In an aspect disclosed herein, it is contemplated that conversational learning system 130 may be configured as an AI-CLAS, wherein conversations facilitated by conversational learning system 130 are generative AI conversations with a learner via learner device 120 (e.g., a mobile phone, tablet, laptop, desktop computer, etc.). For instance, conversational learning system 130 may be configured to utilize a large language model (LLM) 132 to generate responses and interact with learners, wherein the LLM 132 may be coupled with an extractive data model 134 that includes extractive data from a learner's input over time, which enable conversational learning system 130 to create predictive learner profiles that are stored in a user data model 136.

In another aspect disclosed herein, it is contemplated that conversational learning system 130 may be configured to similarly engage in generative AI conversations with associates of a learner (e.g., parents, teachers, psychologists, etc.) via learner associate device(s) 140 (e.g., a mobile phone, tablet, laptop, desktop computer, etc.). Namely, conversational learning system 130 may be configured to engage in generative AI conversations with associates of a learner, wherein extractive data model 134 further includes data extracted from learner associates over time, and wherein the predictive learner profile of a learner stored in user data model 136 may be revised based on the data extracted from the learner associate.

In yet another aspect disclosed herein, it is contemplated that conversational learning system 130 may be configured to leverage any of various external resources 150 for a plurality of reasons. For instance, conversational learning system 130 may be configured to leverage external resources 150 to identify and/or retrieve resources for a learner based on the ongoing generative AI conversations associated with the learner (e.g., educational resources, career resources, social-emotional resources, etc.). In another example, conversational learning system 130 may leverage external resources 150 for computational and/or data storage purposes (e.g., cloud-based computing and/or data storage).

As used herein, it should be appreciated that generative AI broadly refers to a subset of AI systems designed to produce new, original content. Such systems may utilize advanced algorithms and deep learning techniques to learn patterns from extensive datasets and generate novel outputs that are often indistinguishable from human-created content. Core methods in generative AI include Generative Adversarial Networks (GANs) and Variational Autoencoders (VAEs). GANs consist of two neural networks—a generator that creates data and a discriminator that evaluates its authenticity. This adversarial training process enhances the generator's ability to produce realistic content. VAEs operate by encoding input data into a latent space and then decoding it to generate new data, facilitating controlled and diverse content creation.

As used herein, it should be further appreciated large language models (LLMs), such as LLM 132, are a specific application of generative AI focused on processing and generating human language text. For instance, LLMs may employ transformer architectures, which excel at handling long-range dependencies in text through a mechanism known as self-attention. This mechanism allows LLMs to process and generate text with high levels of contextual understanding and coherence. A prominent example of LLMs is the Generative Pre-trained Transformer (GPT) series. These models undergo extensive pre-training on large, diverse text corpora to learn language patterns, followed by fine-tuning on specific tasks to optimize performance.

LLMs are capable of performing a wide range of language-related tasks, including text completion, translation, summarization, and conversational response generation. Accordingly, it should be appreciated that LLM 132 may be configured to generate coherent and contextually relevant text to facilitate any of various natural language processing (NLP) applications including, but not limited to, generating human-like responses to communicate via chatbots, avatars, etc., as contemplated herein.

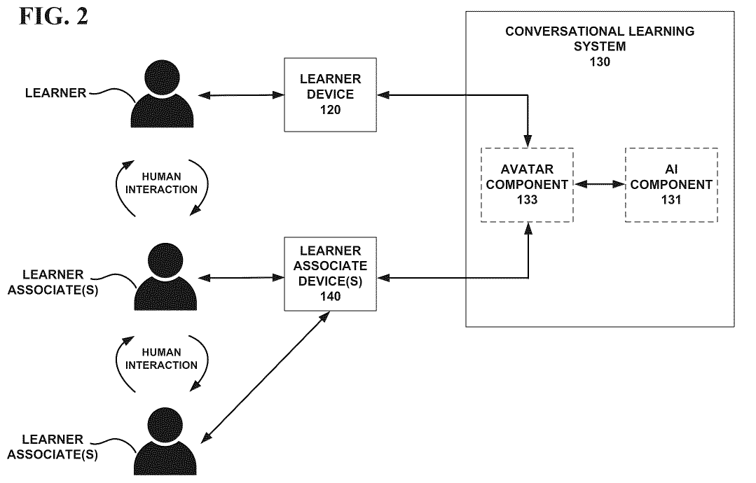

Referring next to FIG. 2, a block diagram is provided illustrating an exemplary conversational learning embodiment in accordance with aspects disclosed herein. In this particular embodiment, it is contemplated that the generative AI conversations facilitated by conversational learning system 130 are communicated via an avatar. For instance, as illustrated, conversational learning system 130 may include avatar component 133, which is configured to create an avatar for interfacing with a learner and/or learner associate. Within such embodiment, it should be appreciated that such avatars may be generated via a coupling of avatar component 133 and AI component 131, wherein AI component 131 may include any combination of LLM 132, extractive data model 134, and/or user data model 136.

As used herein, avatar generation generally refers to creating a digital representation of a character (fictional or non-fictional), which can be utilized in various environments (e.g., web-based applications, augmented reality (AR) applications, virtual reality (VR) applications). For instance, avatar component 133 may be configured to generate a voice avatar and/or a video avatar, wherein video avatars can range from simple two-dimensional (2D) icons to complex three-dimensional (3D) models that mimic a character's appearance and movements.

Referring back to FIG. 2, it should be noted that conversational learning system 130 may be configured to initiate human interactions where such interactions may be more effective and/or efficient than interacting with an avatar. For instance, in addition to having an avatar teach a learner about animals, conversational learning system 130 may recommend a learning experience where a learner associate (e.g., a teacher) takes the learner to a zoo.

Similarly, conversational learning system 130 may recommend human interactions between a learner associate and another learner associate. For instance, conversational learning system 130 may recommend that a parent consult with a mental health professional if the avatar detects conversational patterns indicative of mental health issues. The mental health professional may then be added as a learner associate of the learner, wherein conversational learning system 130 may be configured to extract data from the mental health professional supplement data extracted from the learner and their other learner associates.

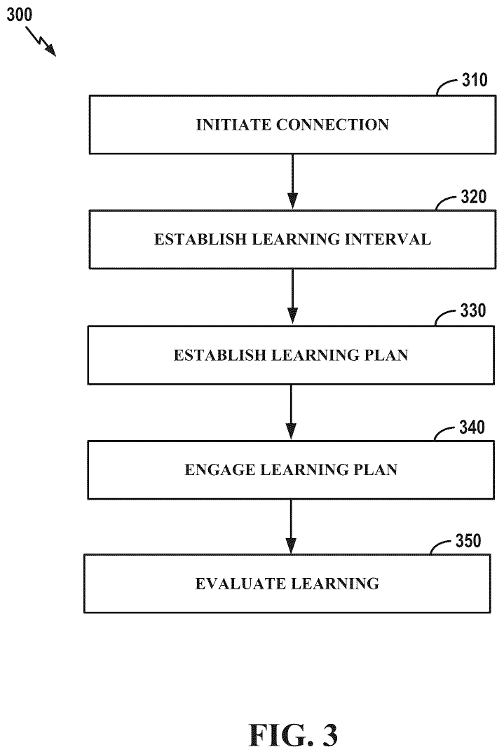

Referring next to FIG. 3, a first flow diagram is provided of an exemplary conversational learning methodology according to an embodiment. As illustrated, process 300 includes a series of acts that may be performed by conversational learning system 130 according to an aspect of the subject specification. For instance, process 300 may be implemented by employing a processor to execute computer executable instructions stored on a computer readable storage medium to implement the series of acts. In another embodiment, a computer-readable storage medium comprising code for causing at least one computer to implement the acts of process 300 is contemplated.

As illustrated, process 300 may begin at act 310 with conversational learning system 130 initiating a social-emotional connection with a learner. For instance, sessions with conversational learning system 130 may begin with questions inviting learners to share their current emotional state through casual prompting. The learner may then be invited to describe their current state more precisely through a series of fun and engaging follow-up questions using multiple question formats and media, including optional breathing exercises.

The type of session “check-in” performed at act 310 may serve any of various purposes. For example, such a connection may build the emotional intelligence of the learner by encouraging reflection, prompted consideration, and precise responsive descriptive vocabulary. Such a connection also generates data for social-emotional growth over time as part of the learner profile and seeds responsive supporting activities that may be provided by conversational learning system 130, such as book recommendations, games, art projects, physical education activities, inquiry questions, etc. Furthermore, the check-in performed at act 310 can facilitate the generation of emotional heat maps for teachers enabling them to direct supportive actions in the classroom and in collaboration with families and other educators. Regular check-ins can also reduce the learner's affective filters by shifting cognitive activity to the prefrontal cortexes associated with critical thinking and abstract thought.

After initiating a connection at act 310, process 300 proceeds to act 320 where conversational learning system 130 establishes a learning interval. Here, conversational learning system 130 may be configured to cross-reference areas of educational strength and need identified through interactions with the teacher and engagements with conversational learning system 130 along with other data sources (e.g., external resources 150). For example, conversational learning system 130 may display this information and invite the learner-through age-appropriate scaffolding—to share their learning priorities and establish goals for the learning interval based on standards, interests, strengths, and needs. The goals thus become an age-appropriate rubric-type tool that guides self-reflection and teacher/conversational learning system 130 evaluation during the learning interval.

Once the learning interval has been established, conversational learning system 130 may then proceed by establishing an appropriate learning plan at act 330. For instance, conversational learning system 130 may be configured to engage the learner in establishing a tentative learning plan by identifying types of learning engagements, content representations, and methods for learning action/representation (e.g., learning plans in accordance with the research-based principles of the Universal Design for Learning framework). In a particular aspect, the method for accomplishing this may be scaffolded to the learner's developmental level and unique learner profile. Once the tentative plan is set, the learner may consult with peers, their teacher, or conversational learning system 130 to help fine-tune elements. The plan then becomes “complete” but remains dynamic and responsive as more data is collected.

At act 340, process 300 then proceeds with engaging the learning plan established at act 330. For instance, conversational learning system 130 may be configured to help the learner and the teacher initiate the plan by populating a corresponding learning agenda. Such a learning agenda may comprise a broad range of mutually reinforcing learning experiences that include and transcend traditional academic tasks. For example, the broad range of activities of a learning agenda may include, but are not limited to: co-creating and enacting plays or skits that bring a concept to life; entering an immersive art activity that helps the learner think about concepts abstractly; gathering evidence about a concept topic and engaging in debate with conversational learning system 130; writing music that brings the concept to life through words and sound; creating and/or playing games with conversational learning system 130 and/or a peer(s) that challenges learners to think strategically about concepts; and/or setting a personal record for a physical activity, like running one mile or mastering a new yoga pose.

Process 300 then concludes at act 350 where conversational learning system 130 evaluates how effectively the learner is learning. In a particular embodiment, conversational learning system 130, the teacher, and the learner are engaging in evaluation throughout the learning interval. Here, the engine of growth is the constant identification, consideration, and implementation of growth opportunities by the learner with support from conversational learning system 130, the teacher, and peers. Any “assessment” is formative and blended into the learning process to the extent that the learner cannot distinguish assessment from learning because there is no distinction. Learning may be periodically decontextualized and differentiated by conversational learning system 130 to challenge learners to transfer concepts and skills into a summative assessment.

It is contemplated that a summative assessment may be comprised of a learning retrospective to reflect on personal social, emotional, and academic growth and to seed future learning goals and ideas. A summative evaluation of a learner's knowledge, skills, and abilities may be generated by hundreds of data points over time generated throughout formal learning product analysis and ongoing natural activities. For example, a summative evaluation of a learner's ability to support claims with evidence could include a scored essay along with a brief interaction with conversational learning system 130, or a response to a peer on a message board.

### Exemplary Advantages

Conversational learning system 130 represents a significant evolution of assessment approaches and technologies in schools today. Computer adaptive testing provides a personalization function of a highly limited scope. However, such technology functions to adjust difficulty levels of standardized summative assessment questions to hone in on a student's discrete skill knowledge quickly, wherein there is no benefit for the learner. Conversational learning system 130, on the other hand, includes teachers and students in learning journeys that originate in the strengths, needs, and interests of the learner. These journeys are curated for personalized learning by the platform's powerful AI under the expert guidance of professional educators.

The dominant model of assessment in education currently situates an assessment at the end of a period of learning and then moves on, wherein assessment is something that happens to learners, rather than with or by learners. Conversational learning system 130, on the other hand, incorporates assessment as a natural, inextricable part of the learning process and maintains a seamless connection from past to future learning. The learner is the active agent in the journey, supported by conversational learning system 130 and their teachers. From the perspective of the learner, there is thus no distinction between assessment and learning.

In the current education system, students have little to no control over what is learned and when it is learned. A learner's strengths, needs, and interests are peripheral considerations. In a particular aspect disclosed herein, conversational learning system 130 is configured to start with curiosity and continually elicit curiosity to move learning forward. Curiosity is systematically connected with inquiry and action through repeated learning journeys guided by professional educators. As learners grow, their curiosity strengthens alongside their capacity to conduct inquiry and create a learning product. Conversational learning system 130 thus harnesses the natural power of curiosity instead of diminishing it to address standards.

### Exemplary Implementations

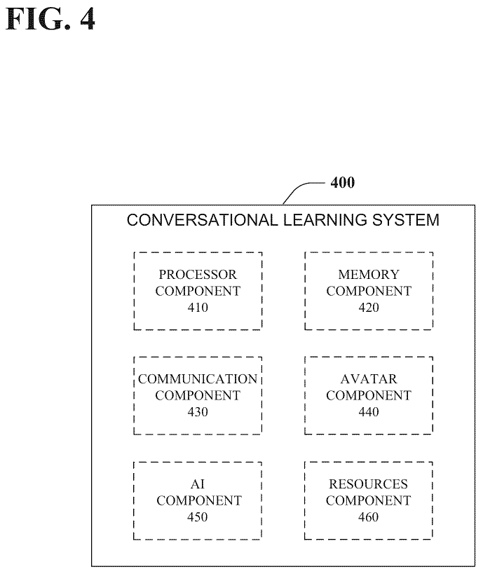

Referring next to FIG. 4, a block diagram of an exemplary conversational learning system is provided, wherein it is contemplated that conversational learning system 400 is substantially similar to conversational learning system 130. As illustrated, conversational learning system 400 may include a processor component 410, a memory component 420, a communication component 430, an avatar component 440 (e.g., substantially similar to avatar component 133), an AI component 450 (e.g., substantially similar to AI component 131), and a resources component 460. Components 410-460 may reside together in a single location or separately in different locations in various combinations, including, for example, a configuration in which at least one of the aforementioned components reside in a cloud.

In one aspect, processor component 410 is configured to execute computer-readable instructions related to performing any of a plurality of functions. Processor component 410 can be a single processor or a plurality of processors which analyze and/or generate information utilized by memory component 420, communication component 430, avatar component 440, AI component 450, and/or resources component 460. Additionally or alternatively, processor component 410 may be configured to control one or more components of conversational learning system 400.

In another aspect, memory component 420 is coupled to processor component 410 and configured to store computer-readable instructions executed by processor component 410. Memory component 420 may also be configured to store any of a plurality of other types of data including data generated by any of communication component 430, avatar component 440, AI component 450, and/or resources component 460. Memory component 420 may be configured to store any of several types of information explained above, including preferred user settings/configurations of conversational learning system 400, for example.

Memory component 420 can be configured in a number of different configurations, including as random access memory, battery-backed memory, Solid State memory, hard disk, magnetic tape, etc. Various features can also be implemented upon memory component 420, such as compression and automatic back up (e.g., use of a Redundant Array of Independent Drives configuration). In one aspect, the memory may be located on a network, such as a “cloud storage” solution.

Communication component 430 may be configured to interface conversational learning system 400 with external entities. For example, communication component 430 may be configured to receive and/or transmit data via a wireless and/or wired network. In a particular embodiment, communication component 430 may be configured to interface with entities via a computer application (e.g., a computer application residing on learner device 120 and/or learner associate device 140).

Avatar component 440 may be coupled to communication component 430 and configured to provide an avatar interface to communicate with entities (e.g., an avatar for learners and learner associates). Here, it should be appreciated that avatars generated by avatar component 440 may be avatars compatible with any of various types of environments (e.g., web-based applications, augmented reality (AR) applications, virtual reality (VR) applications). For instance, avatar component 440 may be configured to generate a voice avatar and/or a video avatar, wherein video avatars can range from simple two-dimensional (2D) icons to complex three-dimensional (3D) models that mimic a character's appearance and movements.

To facilitate engaging in generative AI conversations with learners and learner associates via avatars, avatar component 440 may also be coupled to AI component 450, wherein AI component 450 may comprise any combination of LLM 132, extractive data model 134, and/or user data model 136. Such generative AI conversations may also rely on any of various external resources, wherein resources component 460 may be configured to identify, utilize, and/or retrieve such resources (e.g., from external resources 150).

In an exemplary implementation, it is contemplated that conversational learning system 400 is configured to initiate a generative AI conversation with a learner (e.g., via an avatar generated by avatar component 440), wherein the generative AI conversation is facilitated by an AI LLM (e.g., LLM 132) and configured to elicit learning data from the learner. Conversational learning system 400 may then be further configured to create a learner profile of the user based on the learning data elicited from the learner (e.g., a learner profile stored in user data model 136 based on extractive data from the learner stored in extractive data model 134), and continuously adapt at least one of the generative AI conversation or the learner profile using the AI LLM based on subsequent learning data elicited from the learner.

In a particular aspect of conversational learning system 400, it is contemplated that the generative AI conversation is configured to elicit learning data corresponding to an intellect profile of the learner. For instance, the learning data corresponding to the intellect profile may include the intellectual interests of the learner, the knowledge aptitude of the learner, the intellectual needs of the learner, and/or the proximal development of the learner. Conversational learning system 400 may then be further configured to identify resources (e.g., via resources component 460) based on at least one of the intellectual interests of the learner, the knowledge aptitude of the learner, the intellectual needs of the learner, or the proximal development of the learner, wherein conversational learning system 400 adapts at least one of the generative AI conversation or the learner profile based on the resources. Conversational learning system 400 may also be configured to identify learning experiences based on the proximal development of the learner, wherein conversational learning system 400 adapts at least one of the generative AI conversation or the learner profile based on the learning experiences.

In another aspect disclosed herein, it is contemplated that the generative AI

conversation is configured to elicit learning data corresponding to at least one of a social-emotional skills profile of the learner or an executive function skills profile of the learner. Within such embodiment, conversational learning system 400 may then be further configured to generate a strategy to strengthen the at least one of the social-emotional skills profile of the learner or the executive function skills profile of the learner, wherein conversational learning system 400 adapts at least one of the generative AI conversation or the learner profile based on the strategy.

Conversational learning system 400 may also be configured to monitor the learning progress of the learner, wherein conversational learning system 400 adapts at least one of the generative AI conversation or the learner profile based on the learning progress. Within such embodiment, conversational learning system 400 may be configured to generate an evolving learning strategy based on the learning progress, wherein the evolving learning strategy includes at least one of a learning data elicitation strategy, a resource curation strategy, or a learning experience curation strategy.

In another aspect disclosed herein, conversational learning system 400 may be configured to perform predictions based on data elicited from the generative AI conversations. For instance, conversational learning system 400 may be configured to predict at least one of a college placement of the learner or a career placement of the learner based on the learning data elicited from the learner.

In yet another aspect disclosed herein, conversational learning system 400 may be configured to initiate a second generative AI conversation with a learner associate (e.g., a teacher, parent, etc.), wherein the second generative AI conversation is configured to elicit supplemental data from the learner associate corresponding to the learner profile, and wherein conversational learning system 400 continuously adapts at least one of the generative AI conversation or the learner profile based on the supplemental data elicited from the learner associate. Here, it should be appreciated that the second generative AI conversation may be configured to elicit any of various types of supplemental data including, for example, supplemental data corresponding to an intellect profile of the learner; a social-emotional skills profile of the learner; an executive function skills profile of the learner; and/or a learning progress of the learner.

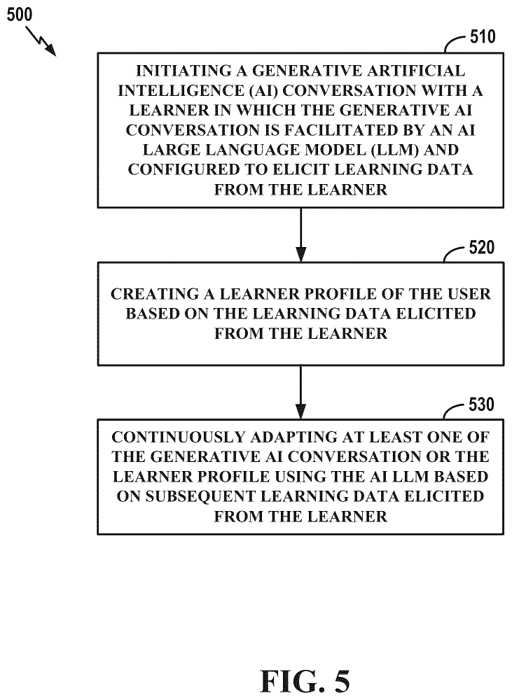

Referring next to FIG. 5, a second flow diagram is provided of an exemplary conversational learning methodology according to an embodiment. As illustrated, process 500 includes a series of acts that may be performed by a conversational learning system (e.g., conversational learning system 130 or 400) according to an aspect of the subject specification, wherein the series of acts may include any of the plurality of acts described with respect to conversational learning system 130 or 400. For instance, process 500 may be implemented by employing a processor to execute computer executable instructions stored on a computer readable storage medium to implement the series of acts. In another embodiment, a computer-readable storage medium comprising code for causing at least one computer to implement the acts of process 500 is contemplated.

As illustrated, process 500 may begin at act 510 with conversational learning system 130 or 400 initiating of a generative AI conversation with a learner in which the generative AI conversation is facilitated by an AI LLM (e.g., LLM 132) and configured to elicit learning data from the learner. At act 520, process 500 then proceeds with conversational learning system 130 or 400 creating a learner profile of the user based on the learning data elicited from the learner. Process 500 then concludes at act 530 with conversational learning system 130 or 400 continuously adapting at least one of the generative AI conversation or the learner profile using the AI LLM based on subsequent learning data elicited from the learner.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

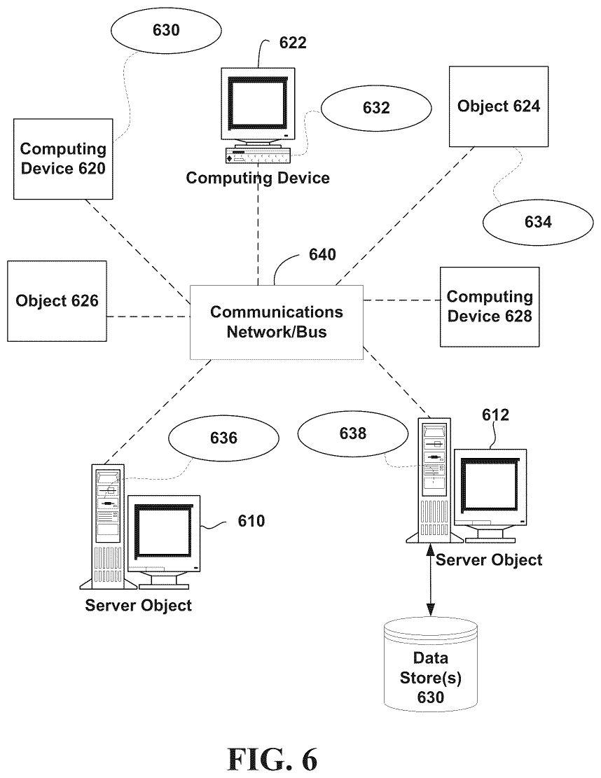

FIG. 6 provides a non-limiting schematic diagram of an exemplary networked or distributed computing environment. The distributed computing environment comprises computing objects or devices 610, 612, etc. and computing objects or devices 620, 622, 624, 626, 628, etc., which may include programs, methods, data stores, programmable logic, etc., as represented by applications 630, 632, 634, 636, 638. It can be appreciated that computing objects or devices 610, 612, etc. and computing objects or devices 620, 622, 624, 626, 628, etc. may comprise different devices, such as PDAs (personal digital assistants), audio/video devices, mobile phones, MP3 players, laptops, etc.

Each computing object or device 610, 612, etc. and computing objects or devices 620, 622, 624, 626, 628, etc. can communicate with one or more other computing objects or devices 610, 612, etc. and computing objects or devices 620, 622, 624, 626, 628, etc. by way of the communications network 640, either directly or indirectly. Even though illustrated as a single element in FIG. 6, network 640 may comprise other computing objects and computing devices that provide services to the system of FIG. 6, and/or may represent multiple interconnected networks, which are not shown. Each computing object or device 610, 612, etc. or 620, 622, 624, 626, 628, etc. can also contain an application, such as applications 630, 632, 634, 636, 638, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects or devices 610, 612, etc. can be thought of as servers where computing objects or devices 610, 612, etc. provide data services, such as receiving data from computing objects or devices 620, 622, 624, 626, 628, etc., storing of data, processing of data, transmitting data to computing objects or devices 620, 622, 624, 626, 628, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 640 is the Internet, for example, the computing objects or devices 610, 612, etc. can be Web servers with which the computing objects or devices 620, 622, 624, 626, 628, etc. communicate via any of a number of known protocols, such as HTTP. As mentioned, computing objects or devices 610, 612, etc. may also serve as computing objects or devices 620, 622, 624, 626, 628, etc., or vice versa, as may be characteristic of a distributed computing environment.

### Exemplary Computing Device

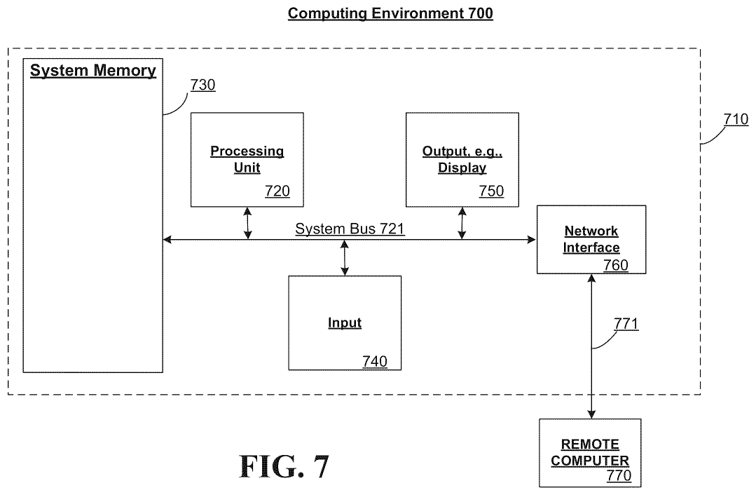

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 7 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 7 thus illustrates an example of a suitable computing system environment 700 in which one or more of the embodiments may be implemented, although as made clear above, the computing system environment 700 is only one example of a suitable computing environment and is not intended to suggest any limitation as to the scope of use or functionality of any of the embodiments. The computing environment 700 is not to be interpreted as having any dependency or requirement relating to any one or combination of components illustrated in the exemplary operating environment 700.

With reference to FIG. 7, an exemplary remote device for implementing one or more embodiments herein can include a general purpose computing device in the form of a handheld computer 710. Components of handheld computer 710 may include, but are not limited to, a processing unit 720, a system memory 730, and a system bus 721 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, memory 730 may also include an operating system, application programs, other program modules, and program data.

A user may enter commands and information into the computer 710 through input devices 740 A monitor or other type of display device is also connected to the system bus 721 via an interface, such as output interface 750. In addition to a monitor, computers may also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 771, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A method, comprising:
employing a processor to execute computer executable instructions stored on a computer readable storage medium to implement the following acts:
initiating a generative artificial intelligence (AI) conversation with a learner, wherein the generative AI conversation is facilitated by an AI large language model (LLM) and configured to elicit learning data from the learner;
creating a learner profile of the user based on the learning data elicited from the learner; and
continuously adapting at least one of the generative AI conversation or the learner profile using the AI LLM based on subsequent learning data elicited from the learner.

2. The method of claim 1, wherein the generative AI conversation is configured to elicit learning data corresponding to an intellect profile of the learner.

3. The method of claim 2, wherein the learning data corresponding to the intellect profile includes at least one of intellectual interests of the learner, knowledge aptitude of the learner, intellectual needs of the learner, or proximal development of the learner.

4. The method of claim 3, further comprising identifying resources based on the at least one of the intellectual interests of the learner, the knowledge aptitude of the learner, the intellectual needs of the learner, or the proximal development of the learner, wherein the continuously adapting comprises adapting the at least one of the generative AI conversation or the learner profile based on the resources.

5. The method of claim 3, further comprising identifying learning experiences based on the proximal development of the learner, wherein the continuously adapting comprises adapting the at least one of the generative AI conversation or the learner profile based on the learning experiences.

6. The method of claim 1, wherein the generative AI conversation is configured to elicit learning data corresponding to at least one of a social-emotional skills profile of the learner or an executive function skills profile of the learner.

7. The method of claim 6, further comprising generating a strategy to strengthen the at least one of the social-emotional skills profile of the learner or the executive function skills profile of the learner, wherein the continuously adapting comprises adapting the at least one of the generative AI conversation or the learner profile based on the strategy.

8. The method of claim 1, further comprising monitoring a learning progress of the learner, wherein the continuously adapting comprises adapting the at least one of the generative AI conversation or the learner profile based on the learning progress.

9. The method of claim 8, wherein the continuously adapting comprises generating an evolving learning strategy based on the learning progress, and wherein the evolving learning strategy includes at least one of a learning data elicitation strategy, a resource curation strategy, or a learning experience curation strategy.

10. The method of claim 1, further comprising predicting at least one of a college placement of the learner or a career placement of the learner based on the learning data elicited from the learner.

11. A method, comprising:
employing a processor to execute computer executable instructions stored on a computer readable storage medium to implement the following acts:
initiating a first generative artificial intelligence (AI) conversation, wherein the first generative AI conversation is with a learner, and wherein the first generative AI conversation is facilitated by an AI large language model (LLM) and configured to elicit learning data from the learner;
creating a learner profile of the user based on the learning data elicited from the learner;
initiating a second generative AI conversation, wherein the second generative AI conversation is with a learner associate, and wherein the second generative AI conversation is configured to elicit supplemental learning data from the learner associate corresponding to the learner profile; and
continuously adapting the first generative AI conversation using the AI LLM based on a combination of the learning data elicited from the learner and the supplemental learning data elicited from the learner associate.

12. The method of claim 11, wherein the second generative AI conversation is configured to elicit supplemental learning data corresponding to an intellect profile of the learner.

13. The method of claim 11, wherein the second generative AI conversation is configured to elicit supplemental learning data corresponding to at least one of a socio-emotional skills profile of the learner or an executive function skills profile of the learner.

14. The method of claim 11, wherein the second generative AI conversation is configured to elicit supplemental learning data corresponding to learning progress of the learner.

15. The method of claim 11, further comprising initiating a third generative AI conversation, wherein the third generative AI conversation is with a second learner associate, and wherein the third generative AI conversation is configured to elicit additional supplemental learning data from the second learner associate corresponding to the learner profile.

16. The method of claim 16, wherein the continuously adapting comprises adapting the at least one of the generative AI conversation or the learner profile based on the additional supplemental learning data elicited from the second learner associate.

17. A method, comprising:
employing a processor to execute computer executable instructions stored on a computer readable storage medium to implement the following acts:
initiating a generative artificial intelligence (AI) conversation with a learner, wherein the generative AI conversation is facilitated by an AI large language model (LLM) and configured to elicit learning data from the learner corresponding to at least one of a social-emotional skills profile of the learner or an executive function skills profile of the learner;
creating a learner profile of the user based on the learning data elicited from the learner;
continuously adapting at least one of the generative AI conversation or the learner profile using the AI LLM based on subsequent learning data elicited from the learner; and
generating a strategy to strengthen the at least one of the social-emotional skills profile of the learner or the executive function skills profile of the learner.

18. The method of claim 17, wherein the continuously adapting comprises adapting the at least one of the generative AI conversation or the learner profile based on the strategy.

19. The method of claim 17, further comprising generating an assessment of the learner based on the at least one of the generative AI conversation or the learner profile.

20. The method of claim 19, wherein the assessment is at least one of a knowledge assessment of the learner, a social-emotional assessment of the learner, an intellectual needs assessment of the learner, or an executive skills function assessment of the learner.
